(19) United States
(12) Patent Application Publication
(10) Pub. No.: US 2009/0103701 A1
(43) Pub. Date: Apr. 23, 2009

(54) Call Screening Via Observing Called-Party Behavior

(75) Inventors: Sachin Garg, Bangalore (IN); Navjot Singh, Denville, NJ (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/874,162

(22) Filed: Oct. 17, 2007

(51) Int. Cl. H04M 3/436

(52) U.S. Cl. 379/142.04; 379/210.02; 379/211.02

(57) ABSTRACT

A method is disclosed that enables the screening of unwanted telephone calls, such as voice or video calls, for one or more called parties. In accordance with the illustrative embodiment of the present invention, an anti-SPAM system receives signaling information for one or more telephone calls made to one or more called parties by a calling party. Although the calling party can be a human caller, in a SPAM-over-Internet-Telephony context the calling party can alternatively be a server or other network element that originates SPAM voice calls for advertising purposes; both possibilities are accounted for in the illustrative embodiment. The anti-SPAM system then observes the behavior of the called party or parties that is exhibited in response to receiving the telephone calls. Based on the observed behavior, the anti-SPAM system then updates one or more rules for handling future telephone calls made to the protected called parties.

The present invention relates to telecommunications in general, and, more particularly, to screening telephone calls.

### BACKGROUND OF THE INVENTION

A data communication network comprises various routers, switches, bridges, hubs, and other network elements that are interconnected and configured to pass data to one another. Data is communicated through the data communication network by passing protocol data units, such as Internet Protocol (IP) packets, Ethernet Frames, data cells, segments, or other logical associations of data, between the network elements by utilizing one or more communication links between the devices. A particular protocol data unit may be handled by multiple network elements and cross multiple communication links as it travels between its source and its destination over the network.

As communication networks have proliferated, corporations and individuals have become reliant on the networks for many different types of communication services. One type of common communication service is the ability to transmit e-mail messages on the network. Since transmission of e-mail messages is generally free, fast, and reliable, e-mail has become a very popular way of communicating over a communication network.

Unfortunately, many individuals and corporations have determined that e-mail can be a cost-effective way of advertising particular products, both wanted and unwanted. Consequently, e-mail has become commonly used to send unwanted information. Unwanted e-mail is commonly referred to as “SPAM” and can take many forms, although SPAM is generally commercial in nature and sent in bulk form to many recipients. The transmission of SPAM on the Internet has increased to such an extent that at one point it was estimated that about 90% of all e-mail traffic on the Internet was SPAM.

Because of the proliferation of SPAM, many e-mail services and network providers are beginning to provide anti-SPAM screening products and services. These products generally filter SPAM at an e-mail server or at the user's personal computer so that the unwanted e-mail messages do not get grouped together with other legitimate e-mail messages. SPAM filters generally detect SPAM e-mail messages by looking at the sender's source address, the subject line of the e-mail message, and other aspects of the e-mail.

Initially, voice communications were carried on a voice network, and data communications such as e-mail were carried on a separate data (Internet Protocol or “IP”) network. For various reasons, the two types of networks are being consolidated so that voice calls may be made over data networks by using a protocol commonly referred to as Voice over IP (VoIP). VoIP uses the Session Initialization Protocol (SIP) or other signaling protocol to establish a voice call on an IP network, and then uses the transport facilities of the IP network to enable the call parties to talk in the same manner as they would if the voice call were connected through the traditional voice network.

Although VoIP has the potential to reduce the costs associated with making telephone calls, it also potentially presents a new problem. Specifically, the reduction in both the cost and difficulty of making an Internet-based telephone call has made it easier for SPAM to be delivered over Internet Telephony. Thus, Internet telephony can potentially be abused over time in the same manner or to the same extent that e-mail has been abused. Unfortunately for telephone users, SPAM over Internet Telephony (or “SPIT”) is likely to be more intrusive than SPAM e-mail has been, since SPIT has the potential to cause a telephone to ring at the user's place of business or home as if it were a legitimate, incoming telephone call. Thus, unlike SPAM which may be ignored, SPIT has the potential to be quite intrusive.

Other forms of SPAM are also developing. For example, SPAM over Instant Messaging (SPIM) and SPAM over Fax (SPAF) have been reported. Additionally, as video telephony becomes prominent, it is possible that that new media may become abused to transmit SPAM video messages. Accordingly, it would be advantageous to provide techniques that address SPAM over voice and video telephony, as well as other types of media transmissions that, in contrast to e-mail, are immediate in nature.

### SUMMARY OF THE INVENTION

The present invention enables the screening of unwanted telephone calls, such as voice or video calls, for one or more called parties. In accordance with the illustrative embodiment of the present invention, an anti-SPAM system receives signaling information for one or more telephone calls made to one or more called parties by a calling party. Although the calling party can be a human caller, in a SPAM-over-Internet-Telephony context the calling party can alternatively be a server or other network element that originates SPAM voice calls for advertising purposes; both possibilities are accounted for in the illustrative embodiment. The anti-SPAM system then observes the behavior of the called party or parties that is exhibited in response to receiving the telephone calls. Based on the observed behavior, the anti-SPAM system then updates one or more rules for handling future telephone calls made to the protected called parties.

The system of the illustrative embodiment takes advantage of the real-time nature of SPAM over Internet Telephony, in which a called party is observed in terms of how she reacts to one or more incoming telephone calls. For example, the anti-SPAM system might observe that the called party disconnects from a call within only a few seconds or does not answer the calls from a particular calling party, in which cases the system marks future calls from the suspect calling party as being unwanted. In contrast, the anti-SPAM system might observe that the called party has remained on a call for a convincingly long enough interval, such as a minute, and as a result infers that the calling party is genuine and that future calls from the calling party should be allowed.

The technique of the illustrative embodiment is advantageous over some techniques in the prior art. In the prior art, various approaches enable a called party to block calls from particular calling parties through the use of “black lists,” or alternatively to establish a “white list” of approved calling parties. However, in those prior-art approaches, the called party must be proactive in establishing the black lists and white lists, which can be difficult and confusing to a non-technical user, as well as cumbersome to users in general. In contrast, technique of the illustrative embodiment infers call-screening rules from observed user behavior, thereby performing call screening in a more user-friendly and convenient manner.

The illustrative embodiment of the present invention comprises: receiving, at a data-processing system, signaling information for a first telephone call made to a called party; observing a behavior of the called party in response to the called party receiving the first telephone call; and updating a rule for handling a second telephone call to the called party, based on the behavior observed

### BRIEF DESCRIPTION OF THE DRAWINGS

FIG. 1 depicts telecommunications system 100 in accordance with the illustrative embodiment of the present invention.

FIG. 2 depicts the salient components of anti-SPAM system 112, in accordance with the illustrative embodiment of the present invention.

FIG. 3 depicts a flowchart of the salient tasks that are related to screening one or more calls, in accordance with the illustrative embodiment of the present invention.

### DETAILED DESCRIPTION

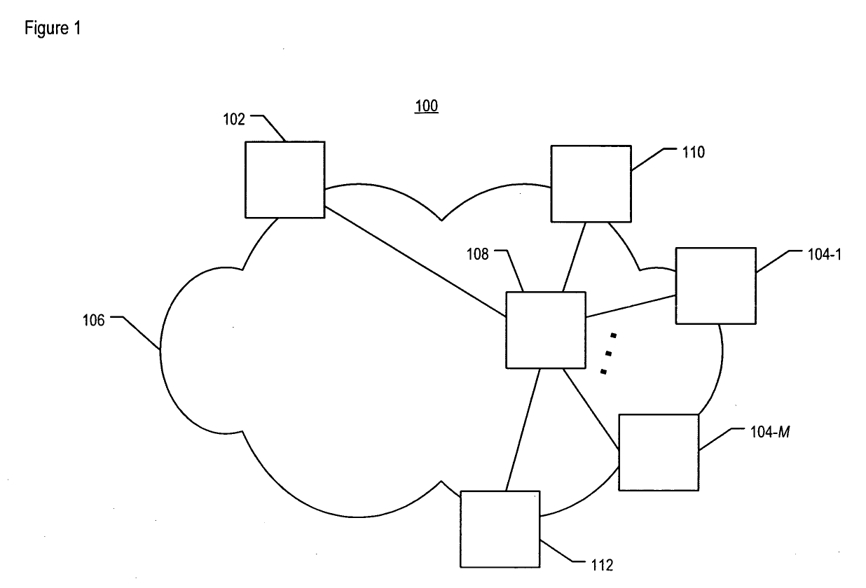

FIG. 1 depicts telecommunications system 100 in accordance with the illustrative embodiment of the present invention. System 100 comprises calling-party endpoint 102; called-party endpoints 104-1 through 104-M, wherein M is a positive integer; network 106; call-processing server 108; mailbox server 110; and anti-SPAM system 112, interconnected as shown. In accordance with the illustrative embodiment, system 100 comprises Voice over Internet Protocol (VoIP) endpoints and servers that are capable of enabling telecommunications that involves VoIP calls. However, it will be clear to those skilled in the art, after reading this specification, how to make and use alternative embodiments of the present invention in which system 100 enables telecommunications that involves non-VoIP telephone calls, such as video calls, or in which system 100 enables telecommunications in general, such as Instant Messages (IM) or other messaging that is not necessarily VoIP-based.

Calling-party endpoint 102 is a telecommunications terminal that is capable of initiating a telephone call to one or more of called-party endpoints 104-1 through 104-M via network 106, in well-known fashion. Called-party endpoint 104-m, for m=1 through M, is also a telecommunications terminal that is capable of receiving telephone calls from calling-party endpoint 102, or from other calling-party endpoints via network 106. Network 106 is a datagram packet-based network such as an Internet Protocol network that is capable of storing and forwarding packets related to telephone calls between one endpoint and another. For example, network 106 can be the public Internet or a private, service provider network.

Call-processing server 108 sets up the calls between a calling endpoint and a called endpoint, in well-known fashion. The signaling information that accompanies the telephone calls is processed by server 108 and is also made available by the server to other network elements, such as system 112. Additionally, status information about each call is also provided to system 112, before and after the call has been answered. For example, system 112 can provide information such as whether or not the called party answers the call, how long the called party remains on an answered call before disconnecting, and so forth. Server 108 is also able to dispose of unanswered calls by routing the calls to mailbox server 110, which is able to play an outgoing message to the calling party.

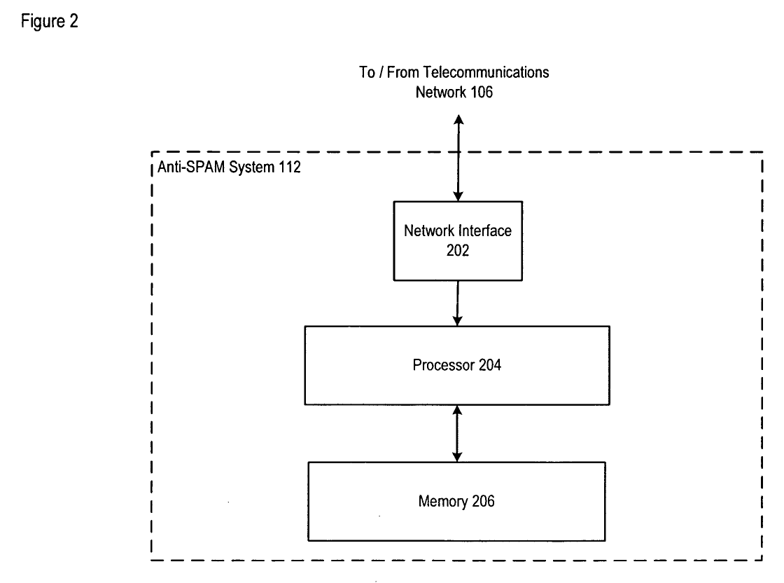

Anti-SPAM system 112 is a data-processing system that provides anti-SPAM services for detecting unsolicited, unwanted telephone calls before they are routed to the called parties, in accordance with the illustrative embodiment of the present invention. For the purposes of this specification and claims, the term “SPAM” refers not only to SPAM e-mail, but also to SPAM over Internet Telephony (SPIT), SPAM over Video Telephony (SPOV), SPAM over Instant Messaging (SPIM), SPAM over Fax (SPAF), and other types of unsolicited, unwanted telecommunications. The salient components of anti-SPAM system 112 are depicted in additional detail with respect to FIG. 2.

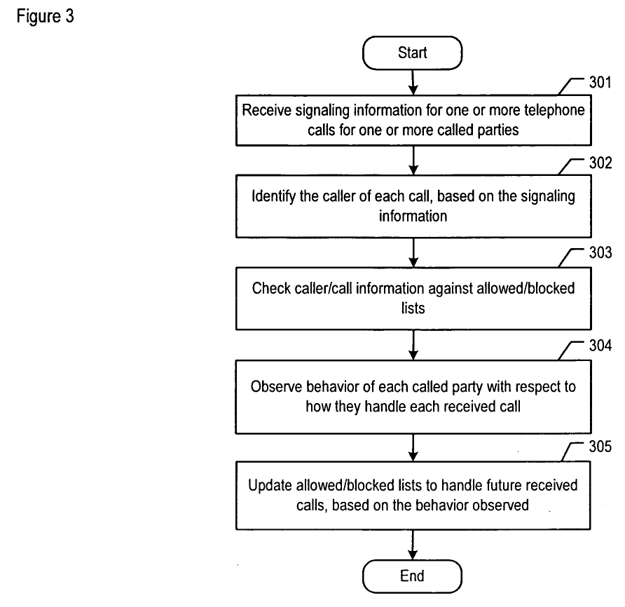

When a telephone call and the signaling associated with the call are passed from calling-party endpoint 102 to called-party endpoint 104-m, system 112 receives at least a portion of the transacted signaling information from call-processing server 108, in order to determine if the call is unwanted. System 112 then performs SPAM detection in accordance with the illustrative embodiment to determine if the telephone call is, in fact, SPAM. The salient tasks performed by system 112 are described below and with respect to FIG. 3.

In accordance with the illustrative embodiment, system 112 serves multiple called-party endpoints 104-1 through 104-M. Although system 112 is depicted as a standalone network element, such as a router on network 106, as some alternative embodiments, the anti-SPAM functionality that system 112 provides may be provided via a different network configuration, such as at a gateway between different administrative portions of the network 106 or together with other services that are provided in network 106. For example, the anti-SPAM service of the illustrative embodiment may be provided at call-processing server 108 or mailbox server 110, or both. In other words, the present invention is well-suited for operation on a dedicated network element or in a network element that is already providing other services.

FIG. 2 depicts the salient components of anti-SPAM system 112, in accordance with the illustrative embodiment of the present invention. System 112 comprises network interface 202, processor 204, and memory 206, interconnected as shown.

Network interface 202 comprises the circuitry that enables system 112 to exchange signals with one or more other network elements in telecommunications system 100, in well-known fashion. In accordance with the illustrative embodiment, system 112 receives and transmits signaling information for telephone calls that is represented in Internet Protocol packets, in well-known fashion. As those who are skilled in the art will appreciate, in some alternative embodiments system 112 receives and transmits signaling information that is represented in a different format than the Internet Protocol.

Processor 204 is a general-purpose processor that is capable of receiving information from network interface 202, of executing instructions stored in memory 206, of reading data from and writing data into memory 206, and of transmitting information to network interface 202. In some alternative embodiments of the present invention, processor 204 might be a special-purpose processor. Processor 204 performs the call screening function at system 112, described below and with respect to FIG. 3.

Memory 206 stores the instructions and data used by processor 204, in well-known fashion. The memory might be any combination of dynamic random-access memory (RAM), flash memory, disk drive memory, and so forth. In accordance with the illustrative embodiment, memory 206 stores the anti-SPAM software executed by processor 204 and a database of the already-identified callers and calls that are associated with SPAM. For example, the SPAM database might include “white lists” or “black lists,” or both, as are well-known in the art.

FIG. 3 depicts a flowchart of the salient tasks that are related to screening one or more incoming calls, as performed by anti-SPAM system 112, in accordance with the illustrative embodiment of the present invention. As those who are skilled in the art will appreciate, some of the tasks that appear in the flowchart can be performed in parallel or in a different order than that depicted. Moreover, those who are skilled in the art will further appreciate that in some alternative embodiments of the present invention, only a subset of the depicted tasks are performed.

At task 301, system 112 receives signaling information related to one or more telephone calls made to one or more called-party endpoints 104-m, in accordance with the illustrative embodiment of the present invention. System 112 receives the signaling information for each call from call-processing server 108, which in turn has received the incoming call from calling-party endpoint 102 or possibly another calling-party endpoint. The signaling information comprises, among other data, an identifier of the calling party, the dialed number of the called party (or other called-party identifier), and so forth.

At task 302, system 112 identifies the calling party that is associated with each call, based on the received signaling information. In this example, the calling party of each call is at endpoint 102; however, as those who are skilled in the art will appreciate, a group of called-party endpoints can receive calls from more than one calling-party endpoint.

At task 303, system 112 checks the incoming calls or calling parties, or both, against a database of already-allowed or already-blocked calls that is stored in memory 206. If the calls from a particular calling party have already been blocked, as determined in a previous iteration of the illustrative embodiment technique, system 112 informs call-processing server 108 to block the unwanted call and to possibly give the call alternative treatment, such as routing the call to a junk-mail box (e.g., at mailbox server 110, etc.). Otherwise, system 112 signals to call-processing server 108 to put the call through to the called party, or at least does not attempt to block the call.

At task 304, system 112 observes the behavior of each called party with respect to how the called party deals with the telephone call that has been put through to the called party at task 303. For example, system 112 might observe that the called party answers the call, but is then only on the call for less than a first predetermined time interval (e.g., five seconds, etc.) before he hangs up. As another example, system 112 might observe that the called party repeatedly disregards calls from the same calling-party number at least N times (e.g., three times, etc.). In accordance with the illustrative embodiment, system 112 “observes” the behavior by receiving status updates from call-processing server 108, which monitors the progress of the call.

At task 305, based on the behavior observed at task 304, system 112 updates a rule that is used to determine whether to allow or block future calls from a particular calling party. The affected calling party either can be the same as the calling party from whom the call was received at task 301 or can be different. In updating the rule, system 112 updates the database entry that corresponds to the calling party to either specifically allow or block future calls from the particular calling party.

If system 112 determines that a first calling party originates wanted calls, system 112 can put the first calling party's identifier on a “white list,” which is then used going forward to indicate that calls from the first calling party are allowed. For example, if system 112 has observed that the called party remained on a call for more than a second predetermined time interval (e.g. one minute, etc.) before disconnecting, the system might conclude that future calls from the calling party should be allowed, and the calling party is put on the white list.

Alternatively, if system 112 determines that a second calling party originates unwanted calls, system 112 can put the second calling party's identifier on a “black list,” which is then used going forward to indicate that calls from the second calling party are to be blocked or given alternative treatment other than routing the calls to the called party. For example, if system 112 has observed that the called party disconnected from a call within a relatively short interval (e.g., five seconds, etc.), the system might conclude that future calls from the calling party should be blocked or given alternative treatment, and the calling party is put on the black list. As another example, if system has observed that multiple called parties have ignored a call from a particular call party at least once, or that one called party has ignored multiple calls from the particular call party, the system might conclude that future calls from the called party should be blocked or given alternative treatment, and the calling party is put on the black list.

With respect to giving calls alternative treatment, system 112 might inform call-processing server 108 to direct unwanted calls to a voice mailbox supported by mailbox server 110. In the event that the “unwanted” call should actually have been allowed, in some embodiments server 110 can play an outgoing message to the calling party, prompting the calling party to enter a predetermined code (e.g., “Please enter your telephone number”, etc.). If the correct number is entered, server 110 can then infer that the calling party is human instead of a SPAM-generating machine, and can update the calling party's status to “allowed.”

In some embodiments, the called party of a call that is considered to be “blocked” might still be informed of the incoming call, being given the option to answer or ignore the call. In accordance with the illustrative embodiment, system 112 can play a first ringtone to indicate the incoming call, identifying the calling party as being on the black list. To distinguish allowed calls from blocked calls, system 112 might play a second ringtone to indicate another incoming call whose calling party has been put on the white list. System 112 might use a third ringtone to indicate calls whose calling parties have not yet been analyzed as being either unwanted or wanted.

In accordance with the illustrative embodiment, the rule that is updated by system 112 applies solely to the called party of the call received at task 301. As those who are skilled in the art will appreciate, however, the rule that is updated can also affect future incoming calls for other called parties than the one intended to receive the call at task 301. In other words, a single rule might apply to a group of two or more called parties that are served by system 112.

In some embodiments, the signaling information that is associated with multiple calls that are intended for different called parties can be used to affect one or more call-screening rules going forward. For example, system 112 might observe behaviors exhibited by multiple called parties in handling incoming calls and, based on the combination of behaviors, might update a rule for handling future telephone calls from one or more calling parties to one or more of the called parties receiving the calls at task 301.

Although several examples of how the call-screening rules are updated have been provided in this specification, it will be clear to those skilled in the art how to make and use embodiments of the present invention, in which different rules are updated based on different types of observations of the called party's behavior.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, at a data-processing system, signaling information for a first telephone call made to a called party;
observing a behavior of the called party in response to the called party receiving the first telephone call; and
updating a rule for handling a second telephone call to the called party, based on the behavior observed.

2. The method of claim 1 wherein both the first telephone call and the second telephone call are from a first calling party.

3. The method of claim 2 wherein the rule for handling of the second telephone call comprises, when the called party disconnected from the first telephone call within a predetermined time interval after having answered, identifying all calls from the first calling party as being blocked.

4. The method of claim 2 wherein the rule for handling of the second telephone call comprises, when the first telephone call is the Nth call from the first calling party that the called party has not answered, identifying all subsequent calls from the first calling party as being blocked, wherein N is a predetermined integer greater than one.

5. The method of claim 2 wherein the rule for handling of the second telephone call comprises:
identifying the second telephone call as being blocked;
playing a message to the first calling party to enter a predetermined code; and
when the predetermined code is received from the first calling party, identifying the second telephone call as being allowed.

6. The method of claim 2 wherein the rule for handling of the second telephone call comprises:
forwarding the second telephone call to the called party; and
when one or more calls from the first calling party have been identified as being blocked, playing a first ringtone to the called party to indicate the incoming second telephone call.

7. The method of claim 5 further comprising:
forwarding a third telephone call from a second calling party to the called party; and
when one or more calls from the second calling party have been identified as being allowed, playing a second ringtone to the called party to indicate the incoming third telephone call.

8. A method comprising:
receiving, at a data-processing system, signaling information for a first telephone call made to a first called party;
observing a behavior of the first called party in response to the first called party receiving the first telephone call; and
updating a rule for handling a second telephone call to a second called party, based on the behavior observed of the first called party.

9. The method of claim 8 wherein both the first telephone call and the second telephone call are from a first calling party.

10. The method of claim 9 wherein the rule for handling of the second telephone call to the second called party comprises, when the first called party disconnected from the first telephone call within a predetermined time interval after having answered, identifying all calls from the first calling party as being blocked.

11. The method of claim 9 wherein the rule for handling of the second telephone call to the second called party comprises, when the first telephone call is the Nth call from the first calling party that the first called party has not answered, identifying all subsequent calls from the first calling party as being blocked, wherein N is a predetermined integer greater than one.

12. The method of claim 9 wherein the rule for handling of the second telephone call to the second called party comprises:
identifying the second telephone call as being blocked;
playing a message to the first calling party to enter a predetermined code; and
when the predetermined code is received from the first calling party, identifying the second telephone call as being allowed.

13. The method of claim 9 wherein the rule for handling of the second telephone call comprises:
forwarding the second telephone call to the second called party; and
when one or more calls from the first calling party have been identified as being blocked, playing a first ringtone to the second called party to indicate the incoming second telephone call.

14. The method of claim 13 further comprising:
forwarding a third telephone call from a second calling party to the second called party; and
when one or more calls from the second calling party have been identified as being allowed, playing a second ringtone to the second called party to indicate the incoming third telephone call.

15. A method comprising:
receiving, at a data-processing system, i) signaling information for a first telephone call made to a first called party and ii) signaling information for a second telephone call made to a second called party;
observing i) a first behavior of the first called party in response to the first called party receiving the first telephone call and ii) a second behavior of the second called party in response to receiving the second telephone call; and
updating a rule for handling a third telephone call to either the first called party or the second called party, based on both the first behavior and the second behavior observed.

16. The method of claim 15 wherein both the first telephone call and the second telephone call are from a first calling party.

17. The method of claim 16 wherein the rule for handling of the third telephone call comprises, when the first called party disconnected from the first telephone call within a predetermined time interval after having answered, identifying all calls from the first calling party as being blocked.

18. The method of claim 16 wherein the rule for handling of the third telephone call comprises, when the first telephone call is the Nth call from the first calling party that either the first called party or the second called party has not answered, identifying all subsequent calls from the first calling party as being blocked, wherein N is a predetermined integer greater than one.

19. The method of claim 16 wherein the rule for handling of the third telephone call comprises:
identifying the third telephone call as being blocked;
playing a message to the first calling party to enter a predetermined code; and
when the predetermined code is received from the first calling party, identifying the third telephone call as being allowed.

20. The method of claim 16 wherein the rule for handling of the third telephone call comprises:
forwarding the third telephone call to the second called party; and
when one or more calls from the first calling party have been identified as being blocked, playing a first ringtone to indicate the incoming third telephone call as being blocked.
